(19) United States
(12) Patent Application Publication
(10) Pub. No.: US 2017/0372370 A1
(43) Pub. Date: Dec. 28, 2017

(54) MODIFYING A PUSH NOTIFICATION IN RESPONSE TO AN EVENT

(71) Applicant: International Business Machines Corporation, Armonk, NY (US)

(72) Inventors: Feras N. Alnatsheh, Brooklyn, NY (US); Michael J. Bordash, Newtown, CT (US); Lisa Seacat DeLuca, Baltimore, MD (US)

(21) Appl. No.: 15/191,653

(22) Filed: Jun. 24, 2016

(51) Int. Cl. G06Q 30/02; G06Q 30/06; H04L 29/08

(52) U.S. Cl. CPC G06Q 30/0268; H04L 67/26; G06Q 30/0267; G06Q 30/0631

(57) ABSTRACT

Embodiments of the present invention provide methods and systems for modification and/or removal of a push notification from a mobile device upon an event such as exit from an area. A positioning system tracks the location of a mobile device through an area. A push notification is presented to the mobile device while the device is in or near the area. If the user exits the area without acknowledgement of the message, the message is modified or removed.

### FIELD OF THE INVENTION

The present invention relates generally to sending and modifying a push notification in response to an event.

### BACKGROUND

Mobile devices such as smart phones and tablets have become commonplace consumer items. Many people carry such a device with them as they shop. These devices have the communication and processing capability to perform location-aware functionality. Modern retail establishments often include multiple departments such as groceries, home goods, shoes, and jewelry, to name a few. This technology allows for an interactive shopping experience in a physical “brick-and-mortar” retail establishment that provides some features of an online shopping experience. Customers can use their mobile devices such as cell phones, tablet computers, and/or wearable technology as part of a retail shopping experience. As more and more consumers obtain such mobile devices, it is desirable to have improvements in interactive retail shopping experiences.

### SUMMARY OF THE INVENTION

In one aspect, embodiments provide a computer-implemented method of controlling activation of an electronic notification, the method comprising: associating an electronic notification with an area; determining that a mobile device of a user has triggered a first event associated with the area, wherein the mobile device comprises an electronic display; sending the electronic notification to the mobile device upon determination of the first event triggering; determining whether the electronic notification is unacknowledged; and modifying the electronic notification on the electronic display if the mobile device triggers a second event and the electronic notification is unacknowledged.

In another aspect, embodiments provide a device comprising: a processor; a memory coupled to the processor; a network interface coupled to the processor; a location receiver coupled to the processor, wherein the memory contains instructions, which when executed by the processor, perform the steps of: associating an electronic notification with an area; determining that a mobile device of a user has triggered a first event associated with the area, wherein the mobile device comprises an electronic display; sending the electronic notification to the mobile device in response to the determination of the first event triggering; determining whether the electronic notification is unacknowledged; and modifying the electronic notification on the electronic display if the mobile device triggers a second event and the electronic notification is unacknowledged.

In yet another aspect, embodiments provide computer program product for controlling activation of an electronic notification on an electronic device, comprising a computer readable storage medium having program instructions embodied therewith, the program instructions executable by a processor to cause the electronic device to: associate an electronic notification with an area; determine that a mobile device of a user has triggered a first event associated with the area, wherein the mobile device comprises an electronic display; send the electronic notification to the mobile device in response to the determination of the first event triggering; determine whether the electronic notification is unacknowledged; and modify the electronic notification on the electronic display if the mobile device triggers a second event and the electronic notification is unacknowledged.

### BRIEF DESCRIPTION OF THE DRAWINGS

Features of the disclosed embodiments will be more readily understood from the following detailed description of the various aspects of the invention taken in conjunction with the accompanying drawings.

FIG. 1 illustrates a usage of an embodiment of the present invention.

FIG. 2 is a system diagram of an embodiment of the present invention.

FIG. 3 is a block diagram of a device in accordance with embodiments of the present invention.

FIG. 4A illustrates a message removal scenario in accordance with embodiments of the present invention.

FIG. 4B illustrates a message modification scenario in accordance with embodiments of the present invention.

FIG. 5 is a flowchart indicating process steps for embodiments of the present invention.

FIG. 6 is a flowchart indicating additional details of process steps for embodiments of the present invention.

The drawings are not necessarily to scale. The drawings are merely representations, not necessarily intended to portray specific parameters of the invention. The drawings are intended to depict only example embodiments of the invention, and therefore should not be considered as limiting in scope. In the drawings, like numbering may represent like elements. Furthermore, certain elements in some of the figures may be omitted, or illustrated not-to-scale, for illustrative clarity.

### DETAILED DESCRIPTION

Embodiments of the present invention provide methods and systems for modification and/or removal of a push notification from a mobile device upon an event such as an exit from an area. A positioning system tracks the location of a mobile device through an area. A push notification is presented to the mobile device while the device is in or near the area. If the user exits the area without acknowledgement of the message, the message is modified or removed.

The terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. It will be further understood that the terms “comprises” and/or “comprising”, or “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof.

Reference throughout this specification to “one embodiment,” “an embodiment,” “some embodiments”, or similar language means that a particular feature, structure, or characteristic described in connection with the embodiment is included in at least one embodiment of the present invention. Thus, appearances of the phrases “in one embodiment,” “in an embodiment,” “in some embodiments”, and similar language throughout this specification may, but do not necessarily, all refer to the same embodiment.

Moreover, the described features, structures, or characteristics of the invention may be combined in any suitable manner in one or more embodiments. It will be apparent to those skilled in the art that various modifications and variations can be made to the present invention without departing from the spirit and scope and purpose of the invention. Thus, it is intended that the present invention cover the modifications and variations of this invention provided they come within the scope of the appended claims and their equivalents. Reference will now be made in detail to the preferred embodiments of the invention.

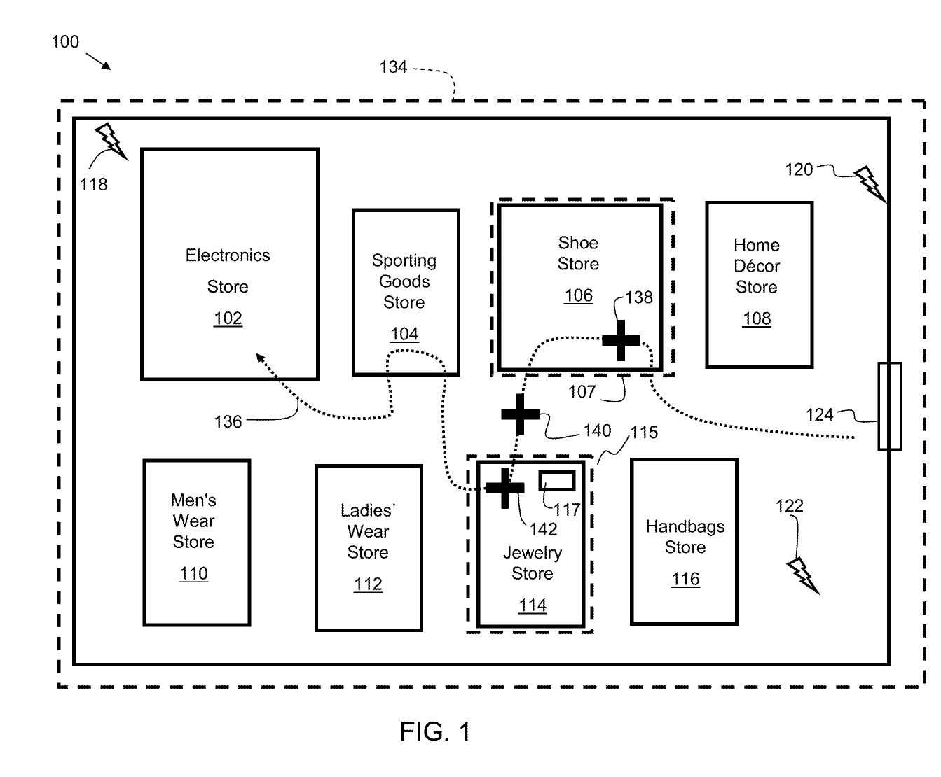

FIG. 1 illustrates a usage of an embodiment of the present invention. In embodiments, an electronic notification is associated with an area. It some embodiments, a geo-json object is used for the association. Geo-json is an open standard format designed for representing simple geographical features, along with their non-spatial attributes, based on JavaScript Object Notation. In some embodiments, another mechanism is used for executing the association. The area can be any suitable area. For example, the area may be an indoor area, a nested indoor area, or an outdoor area, such as a park, parking lot, etc. In the example, the area is a shopping mall 100. Note that the terms, “area” and “zone”, are used interchangeably herein. The mall 100 has entrance 124. In the mall, there are a number of stores—Electronics Store 102, Sporting Goods Store 104, Shoe Store 106, Home Decor Store 108, Men's Wear Store 110, Ladies' Wear Store 112, Jewelry Store 114, and Handbags Store 116. The location detection system may utilize beacons set up in and/or around the venue. In the example, there are three beacons, 118, 120, and 122. In embodiments, the beacons may be WiFi beacons, Bluetooth® beacons, or any other suitable beacons. Although, there are three beacons shown in the example, in implementations, there may be more than three. In some embodiments zones formed in accordance with embodiments of the invention may establish the perimeter and area of a geo-fence. When mobile devices interact with the geo-fence, various actions may be initiated. In the example, zones exist around the perimeter of the venue and around the perimeter of each store. In the example, zone 134 corresponds to the area of the full venue, while zones 107 and 115 correspond to the walls of the Shoe Store 106 and Jewelry Store 114, respectively. Accordingly, zones 107 and 115 are each a “nested indoor area” since they are located within (i.e., “nested in”) the overall venue 134.

In the example, a user carrying a mobile device in his/her pocket enters the mall 100 through entrance 124. The user has previously installed an application, in accordance with embodiments of the invention, to the mobile device. As the user walks through the mall 100, he/she travels among various positions forming path 136. As the user travels the path, it is determined at point 138 that a first event, associated with the area, has been triggered by the mobile device. In embodiments, the first event may be the mobile device approaching the area—the mobile device moving toward the area, but has not yet entered, as determined by distance and directionality of the mobile device compared to the geo-fence. The first event may be the mobile device being within a predetermined distance of the area, e.g., within 20 feet of the geo-fence, from outside of the bounds of the area. The first event may be the mobile device entering the area. The first event may be the mobile device remaining in the area for a predetermined duration. The first event may be the user of the mobile device making a purchase at a point of sale system in the area. The first event may be the mobile device approaching the exit. The first event may be the mobile device being within a predetermined distance from the exit door (e.g., 15 feet) from inside the bounds of the area. The first event may be the mobile device exiting the area. These events are non-limiting examples. Any suitable event may be utilized. In the example, the first event is the mobile device entering the bounds of the Shoe Store 106. As the user entered, his/her mobile device interacted with geo-fence 107.

An electronic notification is sent to the mobile device in response to the determination of the triggering of the first event. The sending may include sending of a message within the application, sending a short message service (SMS) or multimedia messaging services (MMS) message, email, or other method. In some embodiments, the sending includes the application displaying the electronic notification to the user screen. The electronic notification may include content, such as one or more coupons, information about products, services, or special offers, or other suitable content. It is determined whether the electronic notification is acknowledged or unacknowledged. Acknowledgement may include a user of the mobile device opening an SMS text, email, or application message including the electronic notification.

If the electronic notification is unacknowledged, it may be deleted or modified in response to a triggering of a second event. In embodiments, the second event may be the mobile device exiting the area. An example usage scenario for such an embodiment is the removal of a coupon from the mobile device. A scenario may include a user visiting a retail store. The first event is her arrival at the store. In response to the first event, a data server sends a push notification, which is a message that is displayed on the user's mobile device, offering a discount for that day's shopping purchase. If the user makes a purchase and/or leaves the store without noticing the coupon, she may be upset later, after realizing that a coupon was available. With embodiments of the present invention, the purchase and/or exit of the store serves as a second event to trigger the removal of the coupon. Thus, the coupon is removed once a purchase is made and/or the store is exited, thereby avoiding the potential frustration of the customer.

In other embodiments, the second event may be the mobile device approaching the area—the mobile device moving toward the area, but has not yet entered, as determined by distance and directionality of the mobile device compared to the geo-fence. The second event may be the mobile device being within a predetermined distance of the area, e.g., within 20 feet of the geo-fence, from outside of the bounds of the area. The second event may be the mobile device entering the area. The second event may be the mobile device remaining in the area for a predetermined duration. The second event may be the user of the mobile device making a purchase at a point of sale system in the area. The second event may be the mobile device approaching the exit. The second event may be the mobile device being within a predetermined distance from the exit door (e.g., 15 feet) from inside the bounds of the area. These events are non-limiting examples. Any suitable event may be utilized. In the example, the user follows path 136 to position 140. Embodiments, accordingly, determine that the user has exited the Shoe Store 106 as the user passes over geo-fence 107 with the mobile device, thereby triggering the second event. In response, the electronic notification is deleted.

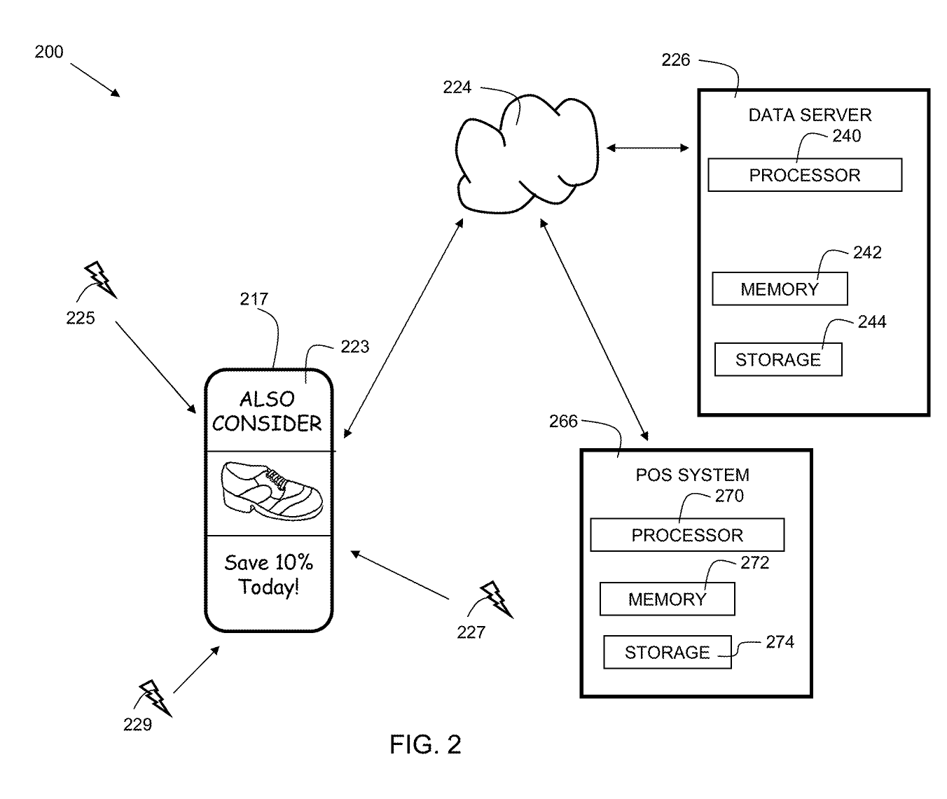

In another example, the user continues along path 136 from position 140 to 142. In this example, the user has traveled with the mobile device into Jewelry Store 114. The entering of the Jewelry Store 114 triggers the first event, which can result in an electronic notification such as a coupon message being sent to the user's mobile device, such as “Today Only—Save 10% on Silver Jewelry.” While in the Jewelry Store 114, the user makes a purchase at a point of sale system (POS) 117. This triggers the second event, the second event being a purchase. The POS 117 may be a cash register, kiosk, or other device where a user can make a purchase. POS 117 communicates with a data server (see POS 266, data server 226, and network 224 of FIG. 2) to indicate a purchase has been made and provide details about the purchase, e.g., the identity of the purchaser (i.e. the user), the item, the cost, etc. The data server sends an electronic notification to the user's mobile device based on one or more items of the purchase information. As the user has made a purchase prior to acknowledgement of the coupon message, the coupon message is removed. In the example, the user exits the jewelry store along path 136. Alternatively, or in addition, exiting the Jewelry Store 114 may trigger another event, as the user's mobile phone interacts with geo-fence 115. This event is the mobile device exiting the Jewelry Store 114. In response to this event, the prior electronic notification (coupon message) may be removed if it wasn't previously removed in response to the purchase at the POS. Alternatively, the electronic notification may be, accordingly, modified (based on a recent purchase and/or other criteria) to recite, “Come back to the Jewelry Store for silver cleaner—Perfect addition to any gift of silver jewelry!”

FIG. 2 is a system diagram 200 of an embodiment of the present invention. Mobile device 217, for example a smartphone, tablet, etc., includes user interface 223. Mobile device 217 is connected via a network 224 to data server 226 and point of sale system 266. Network 224 can be any suitable network, including but not limited to, the Internet, a wide-area network, a local area network, a cloud computing network, etc. Additionally, mobile device 217 may be in communication with three beacons, 225, 227, and 229 for the purpose of location determination. The data server may receive data from the mobile device for processing. Alternatively, or in addition to, the data server may receive processed data from the mobile device for storage. In some embodiments, the device 217 may have zone information stored in memory, and as the device determines its location, it also determines if it has entered/exited a zone, and what action to take. In other embodiments, the device 217 may report its location to the data server 226 via network 224, and the data server 226 may make a determination of if the user has entered/exited a zone. The data server 226 may then send a message to the device 217 instructing the device 217 to remove or modify a message.

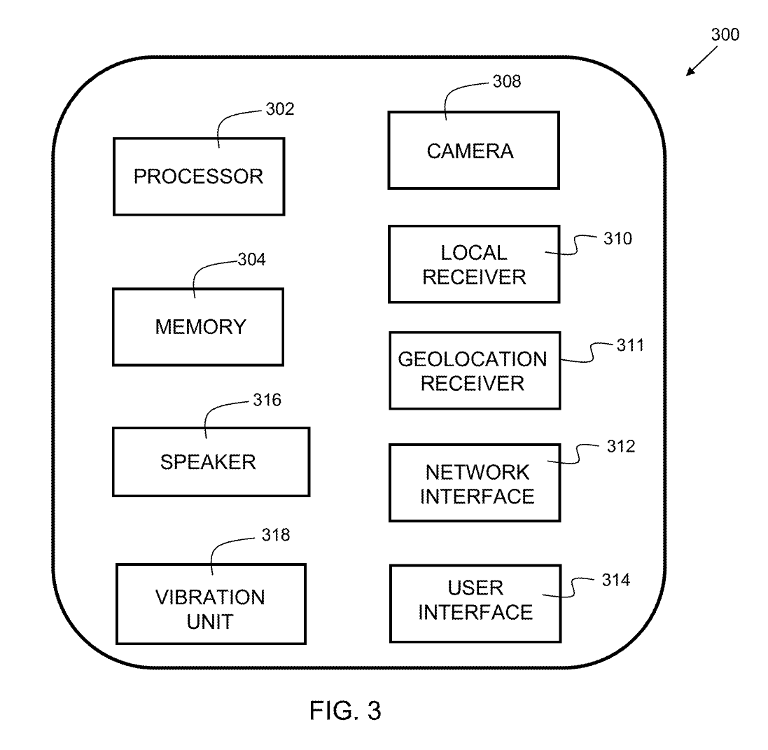

Mobile device has components, explained in detail with regard to FIG. 3. Data server 226 has a processor 240 and a memory 242, as well as storage 244. Point of sale system 266 may be any system that can process the sale of an item or service to the user. For example, without limitation, the point of sale system may be a cash register, or other hardware device or software. POS system 266 has a processor 270 and a memory 272, as well as storage 274. Data server 226 and POS system 266 are each connected to the network 224.

FIG. 3 is a block diagram of a device in accordance with embodiments of the present invention. Device 300 is shown as a simplified diagram of modules. Device 300 includes a processor 302, which is coupled to a memory 304. Memory 304 may include dynamic random access memory (DRAM), static random access memory (SRAM), magnetic storage, and/or a read only memory such as flash, EEPROM, optical storage, or other suitable memory. In some embodiments, the memory 304 may not be a transitory signal per se.

Device 300 further includes a user interface 314, examples of which are a liquid crystal display (LCD), a plasma display, a cathode ray tube (CRT) display, a light emitting diode (LED) display, an organic LED (OLED) display, or other suitable display technology. In some embodiments, user interface 314 may be a touch screen, incorporating a capacitive or resistive touch screen in some embodiments.

The device 300 further includes a network interface 312. The network interface 312 may be a wireless communication interface that includes modulators, demodulators, and antennas for a variety of wireless protocols including, but not limited to, Bluetooth™′ Wi-Fi, and/or cellular communication protocols for communication over network 118.

The device 300 may include a local receiver 310 for determining the position of the device. The local receiver 310 includes a receiver for local radio frequency (RF) signals. In embodiments, the local receiver may include a Bluetooth® receiver, ZigBee® receiver, or other near field communication (NFC) receiver.

Mobile device 300 further may include a geolocation receiver 311. The geolocation receiver may be configured to receive signals from multiple satellites to triangulate a position on Earth. In embodiments, the geolocation receiver 311 includes a Global Positioning System (GPS) receiver, GLONASS receiver, Galileo receiver, or other satellite-based positioning system.

In some embodiments, the device 300 may have the form factor of a tablet computer, smart phone, or other mobile device. Accordingly, the device 300 may include a speaker 316, vibration unit 318, and camera 308.

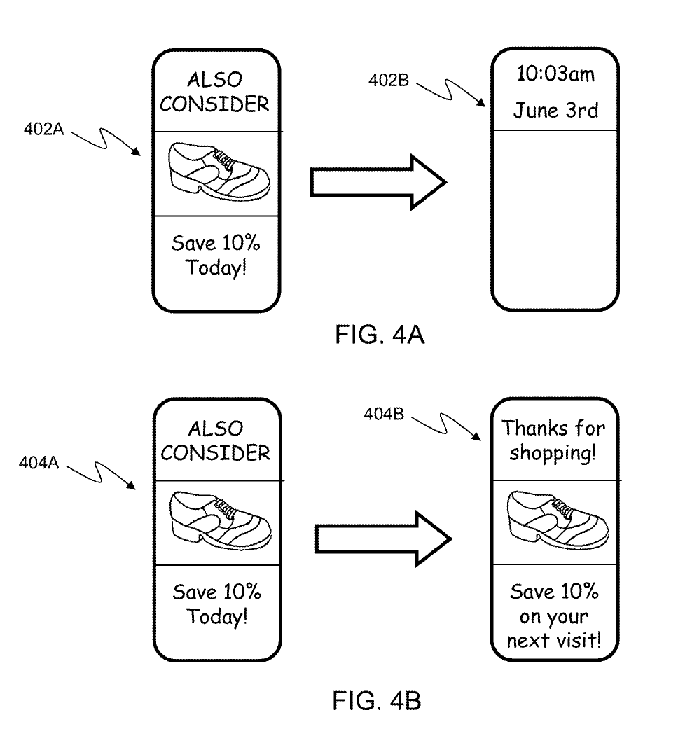

FIG. 4A illustrates a message removal scenario in accordance with embodiments of the present invention. In the example, in response to the determination that a first event has been triggered—the mobile device entering the Shoe Store, an electronic notification 402A is displayed on a screen of the mobile device. In the example, the electronic notification is a coupon. In response to the determination that a second event has been triggered—the mobile device exiting the Shoe Store, the electronic notification is removed from the screen, as shown at 402B.

FIG. 4B illustrates a message modification scenario in accordance with embodiments of the present invention. In the example, in response to the determination that a first event has been triggered—the mobile device entering the Shoe Store—an electronic notification 404A is displayed on a screen of the mobile device. In the example, the electronic notification is a coupon for current use. In response to the determination that a second event has been triggered—the mobile device exiting the Shoe Store, the content of the electronic notification is modified to a coupon for future use at 404B.

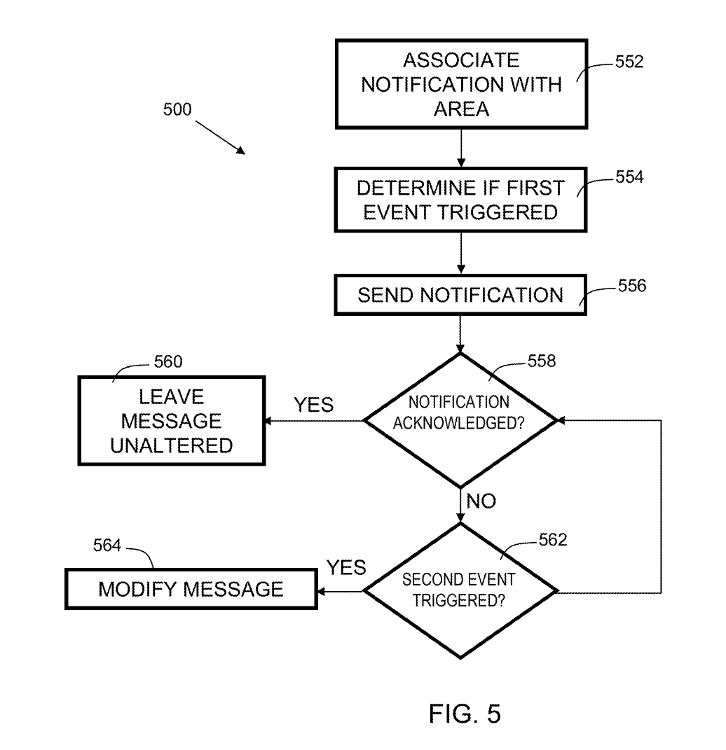

FIG. 5 is a flowchart 500 indicating process steps for embodiments of the present invention. At 552, a notification is associated with the area. At 554, it is determined that a first event has been triggered. The first event may be a mobile device entering a store. In response to the determination, at 556, an electronic notification is sent to the mobile device. At 558, it is determined whether the electronic notification has been acknowledged. If yes, at 560, the message is left unaltered (unless the user deletes, or otherwise disposed of it). If not, at 562, it is determined whether a second event is triggered. If yes, at 564, the content of the electronic notification is modified. The second event may be a mobile device exiting the store, and the modification of the electronic notification may include removal and/or deleting of the electronic notification.

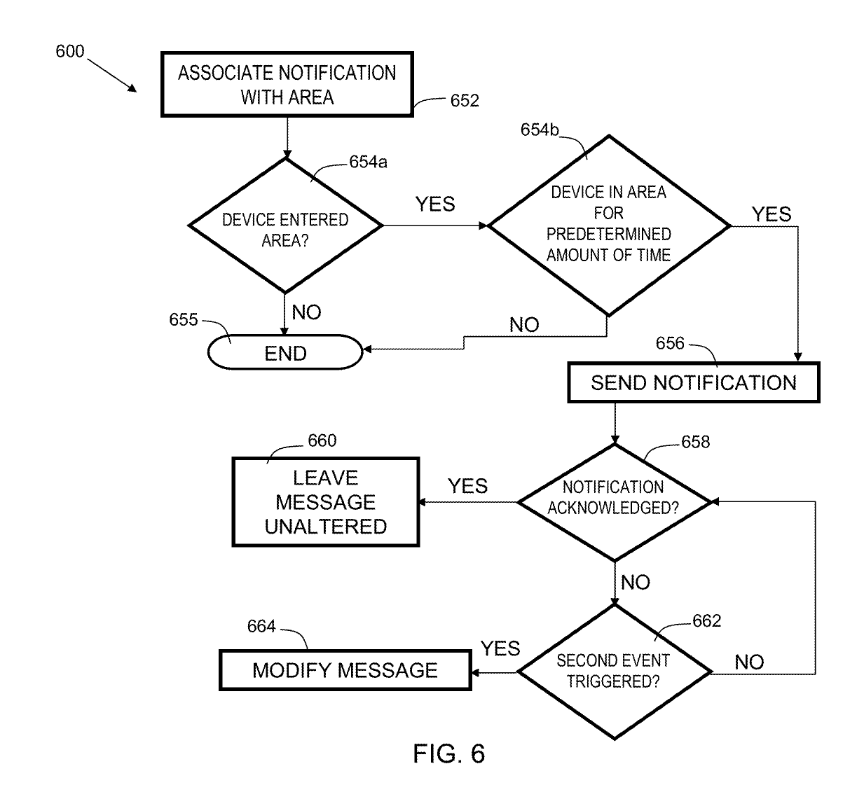

FIG. 6 is a flowchart 600 indicating process steps for embodiments of the present invention. In the embodiment, element 554 has been broken into sub steps, shown as 654a and 654b, for an event based on a duration of time (for example, a predetermined duration of time that a user remains in the area). At 652, a notification is associated with the area. At 654a, it is determined whether the mobile device has entered the area. If no, at 655, the process ends. If yes, at 654b, it is determined whether the user has remained in the area for a predetermined duration of time (e.g., 15 minutes). If no, the process ends at 655. If yes, at 656, an electronic notification is sent to the mobile device. At 658, it is determined whether the electronic notification has been acknowledged. If yes, at 660, the content is left unaltered (unless the user deletes, or otherwise disposed of it). If not, at 662, it is determined whether a second event is triggered. If yes, at 664, the content of the electronic notification is modified. The modification of the electronic notification may include removal and/or deleting of the electronic notification.

Some of the functional components described in this specification have been labeled as systems or units in order to more particularly emphasize their implementation independence. For example, a system or unit may be implemented as a hardware circuit comprising custom VLSI circuits or gate arrays, off-the-shelf semiconductors such as logic chips, transistors, or other discrete components. A system or unit may also be implemented in programmable hardware devices such as field programmable gate arrays, programmable array logic, programmable logic devices or the like. A system or unit may also be implemented in software for execution by various types of processors. A system or unit or component of executable code may, for instance, comprise one or more physical or logical blocks of computer instructions, which may, for instance, be organized as an object, procedure, or function. Nevertheless, the executables of an identified system or unit need not be physically located together, but may comprise disparate instructions stored in different locations which, when joined logically together, comprise the system or unit and achieve the stated purpose for the system or unit.

Further, a system or unit of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices and disparate memory devices.

Furthermore, systems/units may also be implemented as a combination of software and one or more hardware devices. For instance, location determination and alert message and/or coupon rendering may be embodied in the combination of a software executable code stored on a memory medium (e.g., memory storage device). In a further example, a system or unit may be the combination of a processor that operates on a set of operational data.

As noted above, some of the embodiments may be embodied in hardware. The hardware may be referenced as a hardware element. In general, a hardware element may refer to any hardware structures arranged to perform certain operations. In one embodiment, for example, the hardware elements may include any analog or digital electrical or electronic elements fabricated on a substrate. The fabrication may be performed using silicon-based integrated circuit (IC) techniques, such as complementary metal oxide semiconductor (CMOS), bipolar, and bipolar CMOS (BiCMOS) techniques, for example. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor devices, chips, microchips, chip sets, and so forth. However, the embodiments are not limited in this context.

Also noted above, some embodiments may be embodied in software. The software may be referenced as a software element. In general, a software element may refer to any software structures arranged to perform certain operations. In one embodiment, for example, the software elements may include program instructions and/or data adapted for execution by a hardware element, such as a processor. Program instructions may include an organized list of commands comprising words, values, or symbols arranged in a predetermined syntax that, when executed, may cause a processor to perform a corresponding set of operations.

Embodiments of the present invention may also include a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, may be non-transitory, and thus is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Program data may also be received via the network adapter or network interface.

Computer readable program instructions for carrying out operations of embodiments of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of embodiments of the present invention.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

While the disclosure outlines exemplary embodiments, it will be appreciated that variations and modifications will occur to those skilled in the art. For example, although the illustrative embodiments are described herein as a series of acts or events, it will be appreciated that the present invention is not limited by the illustrated ordering of such acts or events unless specifically stated. Some acts may occur in different orders and/or concurrently with other acts or events apart from those illustrated and/or described herein, in accordance with the invention. In addition, not all illustrated steps may be required to implement a methodology in accordance with embodiments of the present invention. Furthermore, the methods according to embodiments of the present invention may be implemented in association with the formation and/or processing of structures illustrated and described herein as well as in association with other structures not illustrated. Moreover, in particular regard to the various functions performed by the above described components (assemblies, devices, circuits, etc.), the terms used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of embodiments of the invention may have been disclosed with respect to only one of several embodiments, such feature may be combined with one or more features of the other embodiments as may be desired and advantageous for any given or particular application. Therefore, it is to be understood that the appended claims are intended to cover all such modifications and changes that fall within the true spirit of embodiments of the invention.

What is claimed is:

1. A computer-implemented method of controlling activation of an electronic notification, the method comprising:
associating an electronic notification with an area;
determining that a mobile device of a user has triggered a first event associated with the area, wherein the mobile device comprises an electronic display;
sending the electronic notification to the mobile device upon determination of the first event triggering;
determining whether the electronic notification is unacknowledged; and
modifying the electronic notification on the electronic display if the mobile device triggers a second event and the electronic notification is unacknowledged.

2. The method of claim 1, wherein modifying the electronic notification further comprises modifying the content of the electronic notification after the mobile device triggers the second event.

3. The method of claim 1, wherein the second event comprises the user making a purchase within the area.

4. The method of claim 1, wherein the second event comprises the mobile device exiting the area.

5. The method of claim 1, wherein the second event comprises the mobile device remaining in the area for a predetermined duration.

6. The method of claim 1, wherein associating an electronic notification with an area comprises using a geo-json object.

7. The method of claim 1, wherein associating an electronic notification with an area comprises associating the electronic notification with an indoor area.

8. The method of claim 1, wherein the modifying comprises deleting the electronic notification.

9. The method of claim 1, wherein associating an electronic notification with an area comprises associating the electronic notification with an outdoor area.

10. A device comprising:
a processor;
a memory coupled to the processor;
a network interface coupled to the processor;
a location receiver coupled to the processor; wherein the memory contains instructions, which when executed by the processor, perform the steps of:
associating an electronic notification with an area;
determining that a mobile device of a user has triggered a first event associated with the area, wherein the mobile device comprises an electronic display;
sending the electronic notification to the mobile device in response to the determination of the first event triggering;
determining whether the electronic notification is unacknowledged; and
modifying the electronic notification on the electronic display if the mobile device triggers a second event and the electronic notification is unacknowledged.

11. The device of claim 10, wherein the memory further contains instructions, which when executed by the processor, perform the step of modifying the electronic notification a predetermined time after the mobile device triggers the second event.

12. The device of claim 10, wherein the memory further contains instructions, which when executed by the processor, perform the step of processing the second event comprising the user making a purchase within the area.

13. The device of claim 10, wherein the memory further contains instructions, which when executed by the processor, perform the step of associating an electronic notification with an area using a geo-json object.

14. The device of claim 10, wherein the modifying comprises deleting the electronic notification.

15. The device of claim 10, wherein the memory further contains instructions, which when executed by the processor, perform the step of processing the first event comprising the mobile device entering the area.

16. A computer program product for controlling activation of an electronic notification on an electronic device, comprising a computer readable storage medium having program instructions embodied therewith, the program instructions executable by a processor to cause the electronic device to:
associate an electronic notification with an area;
determine that a mobile device of a user has triggered a first event associated with the area, wherein the mobile device comprises an electronic display;
send the electronic notification to the mobile device in response to the determination of the first event triggering;
determine whether the electronic notification is unacknowledged; and
modify the electronic notification on the electronic display if the mobile device triggers a second event and the electronic notification is unacknowledged.

17. The computer program product of claim 16, further comprising program instructions executable by the processor to cause the electronic device to process the second event comprising the mobile device exiting the area.

18. The computer program product of claim 16, further comprising program instructions executable by the processor to cause the electronic device to process the second event comprising the user making a purchase within the area.

19. The computer program product of claim 16, further comprising program instructions executable by the processor to cause the electronic device to associate the electronic notification with an indoor area.

20. The computer program product of claim 19, further comprising program instructions executable by the processor to cause the electronic device to associate the electronic notification with an outdoor area.
